(19) United States
(12) Patent Application Publication
(10) Pub. No.: US 2016/0170457 A1
(43) Pub. Date: Jun. 16, 2016

(54) POWER CONTROL CIRCUIT AND ELECTRONIC DEVICE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: KE-YOU HU, Shenzhen (CN)

(21) Appl. No.: 14/597,449

(22) Filed: Jan. 15, 2015

(30) Foreign Application Priority Data
Dec. 11, 2014 (CN) 201410755052.X

(51) Int. Cl. G06F 1/26; G06F 9/44

(52) U.S. Cl. CPC G06F 1/26; G06F 9/442

(57) ABSTRACT

A power control circuit includes a manual switch, a detection module, a first resistor, a first signal switch, a time delay module and a control module. The first resistor outputs a high level signal to the detection module when connected to an external power source. The first signal switch outputs a low level signal according to a received high level signal. The time delay module provides a high level signal to the first signal switch in a delay time when the manual switch is pressed. The control module outputs a high level control signal to shut down a system power supply of a device when the detection module continuously detects a high level signal in a time period less than the delay time, and outputs a low level control signal to power on the system power supply when the detection module detects a low level signal in the time period.

### CROSS-REFERENCE TO RELATED APPLICATIONS

This application claims priority to Chinese Patent Application No. 201410755052.X, filed on Dec. 11, 2014, the contents of which are incorporated by reference herein.

### FIELD

The subject matter herein generally relates to a power control circuit of an electronic device.

### BACKGROUND

Electronic devices, for example, computers, may automatically power on when a power supply is changed. Thus, the electronic device may improperly booted.

### BRIEF DESCRIPTION OF THE DRAWINGS

Implementations of the present technology will now be described, by way of example only, with reference to the attached figures.

FIG. 1 is a block diagram of an electronic device according to an exemplary embodiment.

FIG. 2 is a circuit diagram of the electronic device of FIG. 1.

FIG. 3 is a of a value table of a D-flip flop of the electronic device of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

A definition that apply throughout this disclosure will now be presented.

The term “comprising” means “including, but not necessarily limited to”; it specifically indicates open-ended inclusion or membership in a so-described combination, group, series, and the like.

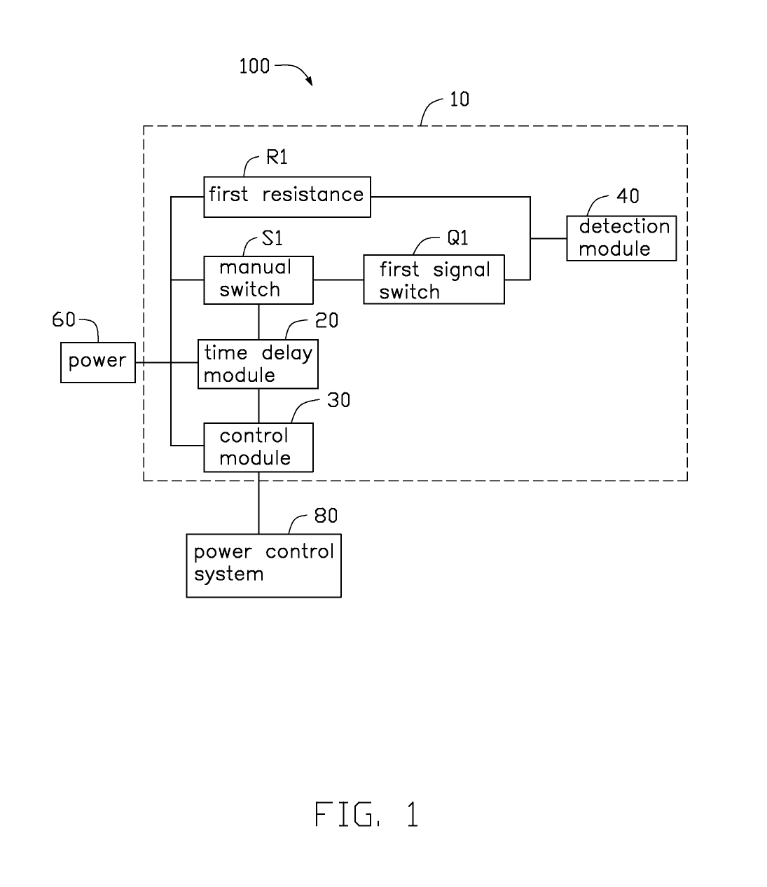

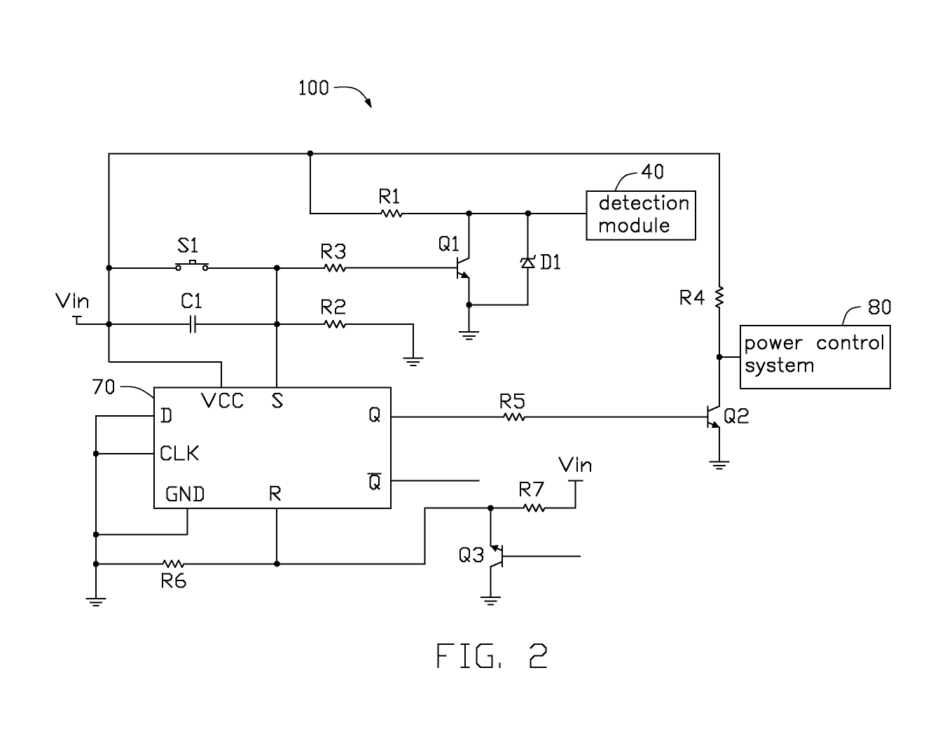

FIGS. 1 and 2 illustrate an electronic device 100 including a power control system 80 and a power control circuit 10 connected to the power control system 80. The power control circuit 10 is configured to prevent the electronic device 100 from automatically powering on when an external power source 60 is changed.

The power control circuit 10 includes a manual switch S1, a time delay module 20, a control module 30, a first signal switch Q1, a first resistor R1 and a detection module 40. The manual switch S1, the time delay module 20, the control module 30 and a first resistor R1 all can connect to an output port Vin of the external power source 60. The first resistor R1 connects to the detection module 40. When the first resistor R1 connects to the output port Vin of the external power source 60, a high level signal is output to the detection module 40. The manual switch S1 connects to the first signal switch Q1 and the time delay module 20. When the manual switch S1 is pressed, the time delay module 20 makes the first signal switch Q1 receive a high level signal in a delay time. The first signal switch Q1 outputs a low level signal to the detection module 40 according to the received high level signal.

When the detection module 40 continuously detects a high level signal in a time period less than the delay time, the control module 30 outputs a high level control signal to the power control system 80. The power control system 80 shuts down a system power supply of the electronic device 100 according to the high level control signal. When the detection module 40 detects a low level signal in a time period less than the delay time, the control module 30 outputs a low level control signal to the power control system 80, the system power supply of the electronic device 100 is powered on according to the low level control signal.

In the embodiment, the time delay module 20 includes a capacitor C1 and a second resistor R2. One end of the capacitor C1 connects to the output port Vin of the external power source 60, and the other end of the capacitor C1 connects to the second resistor R2 and the manual switch S1. The other end of the second resistor R2 is grounded.

The manual switch S1 connects to the first signal switch Q1 through the third resistor R3. The first signal switch Q1 is a transistor. The third resistor R3 connects to a base of the transistor. An emitter of the transistor is grounded. A collector of the transistor connects to a detection port STATE of the detection module 40. When the manual switch S1 is pressed, the transistor turns on. Thus, the detection port STATE receives a low level, and the detection module 40 detects a low level control signal. The collector of the transistor is grounded through a voltage regulator tube D1.

The control module 30 includes a D-flip flop 70, a second signal switch Q2 and a third signal switch Q3. The D-flip flop 70 includes a setting pin S, a reset pin R and an output pin Q.

The setting pin S connects to an end of the capacitor C1 connected to the second resistor R2 and an end of the manual switch S1 connected to the first signal switch Q1. The output pin Q connects to the second signal switch Q2. The second signal switch Q2 further connects to the power control system 80. The power control system 80 further connects to the output port Vin of the external power source 60 through a fourth resistor R4. When the second signal switch Q2 receives a high level signal from the output pin Q, the second signal switch Q2 outputs a low level control signal to the power control system 80.

In the embodiment, the output pin Q connects to the second signal switch Q2 through a fifth resistor R5. The second signal switch Q2 is a transistor. A base of the transistor connects to the output pin Q. An emitter of the transistor is grounded. A collector of the transistor connects to the power control system 80. When the transistor receives a high level signal from the output pin Q, the transistor turns on. Thus, the power control system 80 receives a low level control signal. The reset pin R connects to the third signal switch Q3 and is grounded through a sixth resistor R6. The reset pin R further connects to the output port Vin of an external power source 60 through a seventh resistor R7. When the third signal switch Q3 receives a high level signal, the third signal switch Q3 outputs a low level signal.

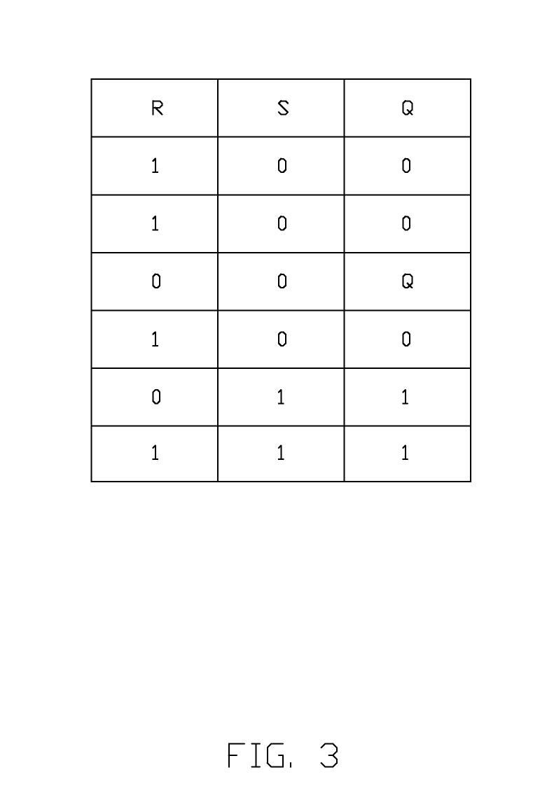

When changing the power supply of the electronic device 100, the detection module 40 detects the high level of the detection port STATE. If the manual switch S1 is pressed, the setting pin S connects to the output port Vin of the external power source 60. Thus, the setting pin S is in a high level, that is, S=1. Because the reset pin R connects to output port Vin of the external power source 60, when the third signal switch Q3 is cut-off, the reset pin R also is in a high level, that is, R=1. FIG. 3 illustrates when R=1, S=1, a value of the output pin Q is 1, that is, the output pin Q is in a high level. Thus, the second signal switch Q2 turns on, then the power control system 80 receives a low level signal, a system of the electronic device 100 is powered. Then, the electronic device 100 is initialized, the third signal switch Q3 receives a high level signal, thus, the third signal switch Q3 turns on, then the reset pin R is in a low level, that is, R=0. After a time period time less than the delay time, the detection module 40 detects the detection port STATE again. If the detection module 40 detects the detection port STATE in a low level, it illustrates that the first signal switch Q1 is turned on and the manual switch S1 is pressed. Thus, the electronic device 100 is powered to run. After a period time more than the delay time, the setting pin S is in a low level signal, that is, S=0. FIG. 3 illustrates when S=0, R=0, the output pin Q keeps the current state, that is, the electronic device 100 is kept powered to run.

After a time period time less than the delay time, if the detection module 40 detects the detection port STATE in a high level, it illustrates that the first signal switch Q1 is cut-off and the manual switch S1 is not pressed. The system of the electronic device 100 is to be powered off. After a period time more than the delay time, the third signal switch Q3 receives a low level signal. Thus, the third signal switch Q3 is cut-off and the reset pin R receives a high level signal, that is, R=1. After a period time more than the delay time, the setting pin S receives a low level, that is, S=0. FIG. 3 illustrates when R=1, S=0, a value of the output pin Q is 0, that is, the output pin Q outputs a low level. Thus, the second signal switch Q2 is cut-off, and the power control system 80 receives a high level. The system of the electronic device 100 is powered off.

The embodiments shown and described above are only examples. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims.

What is claimed is:

1. A power control circuit comprising:
a manual switch configured to be connected to an external power source;
a detection module;
a first resistor configured to output a high level signal to the detection module when the first resistor is connected to the external power source;
a first signal switch configured to output a low level signal to the detection module according to a received high level signal;
a time delay module configured to provide a high level signal to the first signal switch in a delay time when the manual switch is pressed; and
a control module configured to output when the detection module continuously detects a high level signal in a time period less than the delay time a high level control signal to a power control system of an electronic device to shut down a system power supply of the electronic device, and output when the detection module detects a low level signal in a time period less than the delay time a low level control signal to the power control system of an electronic device to power on the system power supply of the electronic device.

2. The power control circuit as claimed in claim 1, wherein the first resistor connects to the first signal switch and the detection module.

3. The power control circuit as claimed in claim 1, wherein the time delay module comprises a capacitance and a second resistor.

4. The power control circuit as claimed in claim 3, wherein one end of the capacitance connects to the external power source, and the other end of the capacitance connects to the second resistor and the manual switch, the other end of the second resistor is grounded.

5. The power control circuit as claimed in claim 4, wherein the control module 30 comprises a D-flip flop, a setting pin of the D-flip flop connects to an end of the capacitance connected to the second resistor and an end of the manual switch connected to the first signal switch.

6. The power control circuit as claimed in claim 5, wherein the control module further comprises a second signal switch and a third signal switch, an output pin of the D-flip flop connects to the second signal switch, the second signal switch further connects to the power control system, a reset pin of the D-flip flop connects to the third signal switch.

7. The power control circuit as claimed in claim 6, wherein the second signal switch is a transistor, a base of the transistor connects to the output pin, an emitter of the transistor is grounded, a collector of the transistor connects to the power control system.

8. The power control circuit as claimed in claim 6, wherein the output pin connects to the second signal switch through a resistor.

9. The power control circuit as claimed in claim 1, wherein the first signal switch is a transistor, the third resistor connects to a base of the transistor, an emitter of the transistor is grounded, a collector of the transistor connects to the detection module.

10. The power control circuit as claimed in claim 9, wherein the collector of the transistor further is grounded through a voltage regulator tube.

11. An electronic device comprising:
a manual switch configured to connected to an external power source;
a detection module;
a first resistor configured to output a high level to the detection module when the first resistor connects the external power source;
a first signal switch configured to outputs a low level signal to the detection module according to a received high level signal;
a time delay module configured to provide a high level signal to the first signal switch in a delay time when the manual switch is pressed;
a control module configured to outputs a high level control signal when the detection module continuously detects a high level signal in a time period less than the delay time, and output a low level control signal when the detection module detects a low level signal in a time period less than the delay time; and
a power control system configured to shut down a system power supply of the electronic device and power on the system power supply of the electronic device.

12. The electronic device as claimed in claim 11, wherein the first resistor connects to the first signal switch and the detection module.

13. The electronic device as claimed in claim 11, wherein the time delay module comprises a capacitance and a second resistor.

14. The electronic device as claimed in claim 13, wherein one end of the capacitance connects to the external power source, and the other end of the capacitance connects to the second resistor and the manual switch, the other end of the second resistor is grounded.

15. The electronic device as claimed in claim 14, wherein the control module 30 comprises a D-flip flop, a setting pin of the D-flip flop connects to an end of the capacitance connected to the second resistor and an end of the manual switch connected to the first signal switch.

16. The electronic device as claimed in claim 15, wherein the control module further comprises a second signal switch and a third signal switch, an output pin of the D-flip flop connects to the second signal switch, the second signal switch further connects to the power control system, a reset pin of the D-flip flop connects to the third signal switch.

17. The electronic device as claimed in claim 16, wherein the second signal switch is a transistor, a base of the transistor connects to the output pin, an emitter of the transistor is grounded, a collector of the transistor connects to the power control system.

18. The electronic device as claimed in claim 16, wherein the output pin connects to the second signal switch through a resistor.

19. The electronic device as claimed in claim 11, wherein the first signal switch is a transistor, the third resistor connects to a base of the transistor, an emitter of the transistor is grounded, a collector of the transistor connects to the detection module.

20. The electronic device as claimed in claim 19, wherein the collector of the transistor further is grounded through a voltage regulator tube.
